(19) United States
(12) Patent Application Publication
(10) Pub. No.: US 2013/0319456 A1
(43) Pub. Date: Dec. 5, 2013

(54) TOOTH FLOSSING DEVICE

(71) Applicant: ERIC SAFIEH, ONTARIO (CA)

(72) Inventor: ERIC SAFIEH, ONTARIO (CA)

(21) Appl. No.: 13/856,929

(22) Filed: Apr. 4, 2013

Related U.S. Application Data
(63) Continuation-in-part of application No. 13/488,922, filed on Jun. 5, 2012.

(51) Int. Cl. A61C 15/04

(52) U.S. Cl. CPC A61C 15/046
USPC 132/323

(57) ABSTRACT

A tooth flossing device comprising a sleeve and a dental floss retainer. The sleeve is releasably receivable over the finger of a user. The dental floss retainer assists in securing a length of dental floss to the sleeve such that the sleeve, when received over the finger of a user, assists in the insertion of the dental floss between the teeth of the user or another. The dental floss retainer comprises a pair of leg members extending outwardly from the surface of the sleeve. The distance between the dental floss, when secured between the leg members, and the sleeve determining the extent to which the dental floss can be inserted between the teeth of a user or another.

### RELATED APPLICATION

This application is a continuation-in-part application which claims priority from U.S. patent application Ser. No. 13/488,922, filed Apr. 17, 2012, which claims priority from U.S. patent application Ser. No. 13/650,698, filed Oct. 12, 2012, which claims priority from U.S. patent application Ser. No. 13/718,449 filed Dec. 18, 2012, the contents of all of which are incorporated herein by reference.

### FIELD

The present invention relates to dental hygiene products, and in particular to a new form of tooth flossing device.

### BACKGROUND

Research has proven that the regular flossing of one's teeth is an integral part of a proper oral healthcare regime. Regular flossing has been shown to assist in the removal of food particles and plaque from between the teeth, to help in the prevention of cavities and decay, and to promote both healthy gums and generally good oral hygiene.

Typically, flossing is accomplished through wrapping a length of dental floss about the index fingers of the user's hands, pulling the floss taut and then working the floss in the space between adjacent teeth through a back and forth and up-and-down motion. Generally such a procedure does not present significant difficulty, however, there are some instances where flossing in the traditional manner can be difficult, if not virtually impossible. For example, individuals with certain medical disorders or disabilities may not have complete use or mobility of their hands and limbs which could severely limit their ability to floss their teeth. In other instances the sick or the infirm may not be able to floss their own teeth and may require the assistance of a caregiver. Similarly, very young children or infants will require a caregiver or parent to either assist in or conduct the flossing.

To provide a level of assistance in situations where the typical manner of flossing is difficult or impractical, others have devised a variety of different devices to aid in flossing, most of which are designed to rigidly secure a length of dental floss so that the floss can be inserted between teeth without the user having to worry about keeping the floss taught. While such devices have been met with some degree of success, they suffer from a number of inherent limitations. Such limitations include their inability to easily present dental floss in an orientation that is perpendicular to the individual's teeth, their bulkiness or clumsiness, and in some cases, due to the nature of their shape or configuration, their potential to cause injury, particularly when used by a caregiver on the teeth of the sick, the infirm or a small child.

### SUMMARY

There is provided a tooth flossing device comprising a sleeve and a dental floss retainer, said sleeve releasably receivable over the finger of a user, said dental floss retainer assisting in securing a length of dental floss to said sleeve such that said sleeve, when received over the finger of a user, assists in the insertion of the dental floss between the teeth of the user or another, said dental floss retainer comprising a pair of leg members extending outwardly from the surface of said sleeve, said leg members having slots dimensioned such that receipt of dental floss into said slots causes a frictional engagement between said slots and the dental floss to releasably secure the dental floss between said leg members, said leg members and said slots arranged such that when dental floss is secured between said leg members the dental floss is generally perpendicular to the longitudinal axis of said sleeve, the distance between the dental floss, when secured between said leg members, and said sleeve determining the extent to which the dental floss can be inserted between the teeth of a user or another.

There is also provided a tooth flossing device comprising an elongate handle and a dental floss retainer positioned on said handle, said dental floss retainer assisting in securing a length of dental floss to said handle, said dental floss retainer comprising a pair of leg members extending outwardly from the surface of said handle, said leg members having slots dimensioned such that receipt of dental floss into said slots causes a frictional engagement between said slots and the dental floss to aid in securing the dental floss between said leg members, said leg members and said slots arranged such that when dental floss is secured between said leg members the dental floss is generally perpendicular to the longitudinal axis of said handle, the distance between the dental floss, when secured between said leg members, and said handle determining the extent to which the dental floss can be inserted between the teeth of a user or another.

Further there is provided a tooth flossing device comprising a sleeve and a dental floss retainer, said sleeve releasably receivable over the finger of a user, said dental floss retainer positioned on said sleeve and assisting in securing a length of dental floss to said sleeve such that said sleeve, when received over the finger of a user, assists in the insertion of the dental floss between the teeth of the user or another, said dental floss retainer comprising a pair of leg members and a guide member, said leg members extending outwardly from the surface of said sleeve and arranged to permit dental floss to extend between said leg members in a generally perpendicular relationship with respect to the longitudinal axis of said sleeve, said guide member extending about at least a portion of the circumference of said sleeve.

In additional there is provided a tooth flossing device comprising a flossing wall mounted to a central body, said flossing wall having a width exceeding that of the width of the teeth of an intended user and a thickness that permits the insertion of said flossing wall between adjacent teeth of the user, such that when said flossing wall is inserted between adjacent teeth of a user movement of said central body in an up and down or a side to side manner relative to the user's teeth causes said flossing wall to clean between said teeth.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side elevational view of one of the preferred embodiments of the tooth flossing device constructed in accordance with the present invention.

FIG. 2 is a bottom view of the tooth flossing device shown in FIG. 1.

FIG. 3 is a sectional view taken along the line 3-3 of FIG. 1.

FIG. 4 is a view similar to FIG. 1 wherein the tooth flossing device has secured to it a length of dental floss and the device is about to be received over the teeth of a user.

FIG. 5 is a view similar to FIG. 4 where the device has been received over the teeth and the dental floss inserted between two adjacent teeth.

FIG. 6 is a top plan view of the tooth flossing device shown in FIG. 5.

FIG. 7 is a lower perspective view of an alternate embodiment of the tooth flossing device shown in FIG. 1.

FIG. 8 is a lateral sectional view taken along the line 8-8 of FIG. 7.

FIG. 9 is an upper side perspective view of an alternate embodiment of the tooth flossing device shown in FIG. 1.

FIG. 10 is a side perspective view of a further embodiment of the tooth flossing device shown in FIG. 1.

FIG. 11 is a sectional view taken along the line 11-11 of FIG. 10.

FIG. 12 is a side perspective view of an alternate embodiment of the tooth flossing device.

FIG. 13 is a side elevational view of the embodiment of the tooth flossing device shown in FIG. 12.

FIG. 14 is an enlarged detail view of portion “A” of FIG. 13.

FIG. 15 is a right hand end view of the tooth flossing device shown in FIG. 12.

FIG. 16 shows yet a further embodiment of the tooth flossing device.

FIG. 17 is a side elevational view of the embodiment of the tooth flossing device shown in FIG. 16.

FIG. 18 is a right hand end view of the tooth flossing device shown in FIG. 16.

FIG. 19 is a further embodiment of the tooth flossing device.

FIG. 20 is a side elevational view of the tooth flossing device shown in FIG. 19.

FIG. 21 is a right hand end view of the tooth flossing device shown in FIG. 19.

FIG. 22 is an upper side perspective view of a further embodiment of the tooth flossing device.

FIG. 23 is a side elevational view of the tooth flossing device shown in FIG. 22.

FIG. 24 is a right hand end view of the tooth flossing device shown in FIG. 22.

FIG. 25 is an upper side perspective view of an alternate embodiment to that shown in FIG. 12.

FIG. 26 is an upper rear perspective view of the embodiment shown in FIG. 25.

FIG. 27 is a sectional view taken along the line 27-27 of FIG. 25.

FIG. 28 is an upper side perspective view of an alternate embodiment to that shown in FIG. 9.

### DESCRIPTION

The present invention may be embodied in a number of different forms. The specification and drawings that follow describe and disclose some of the specific forms of the invention.

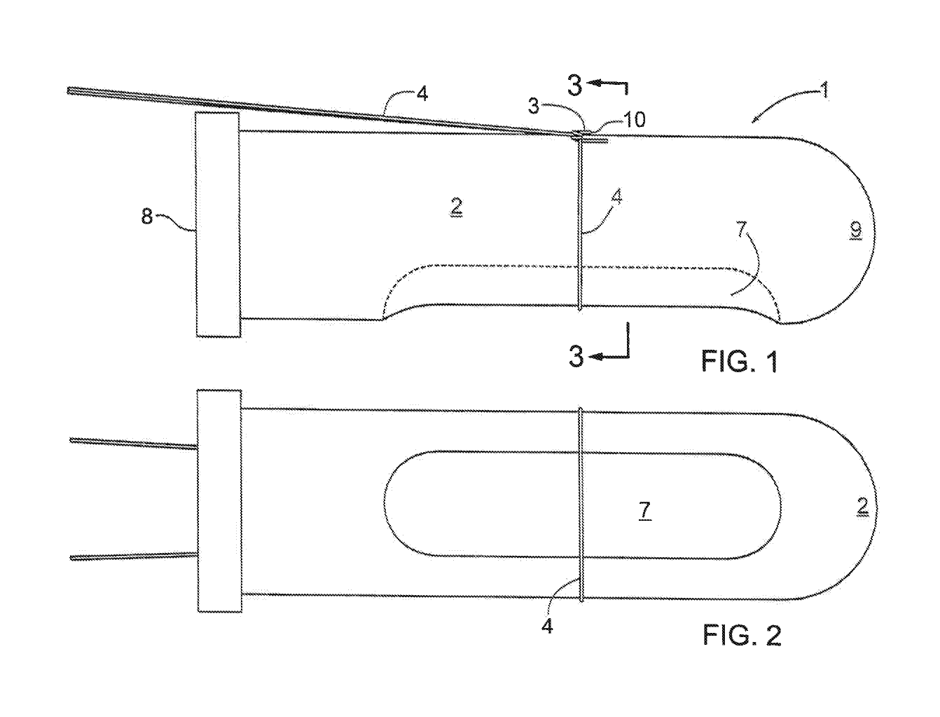

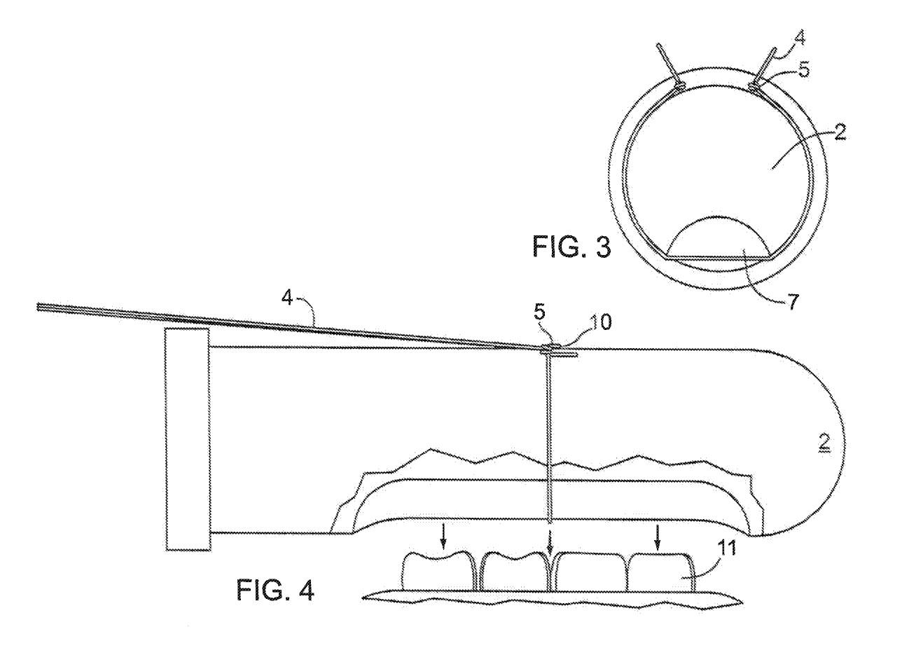

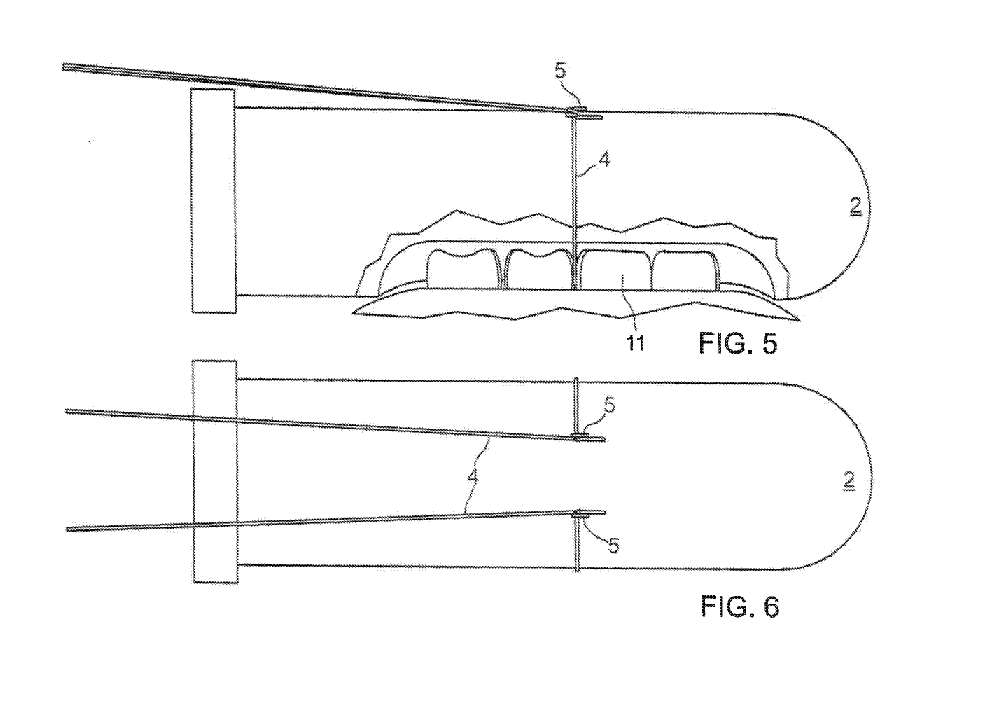

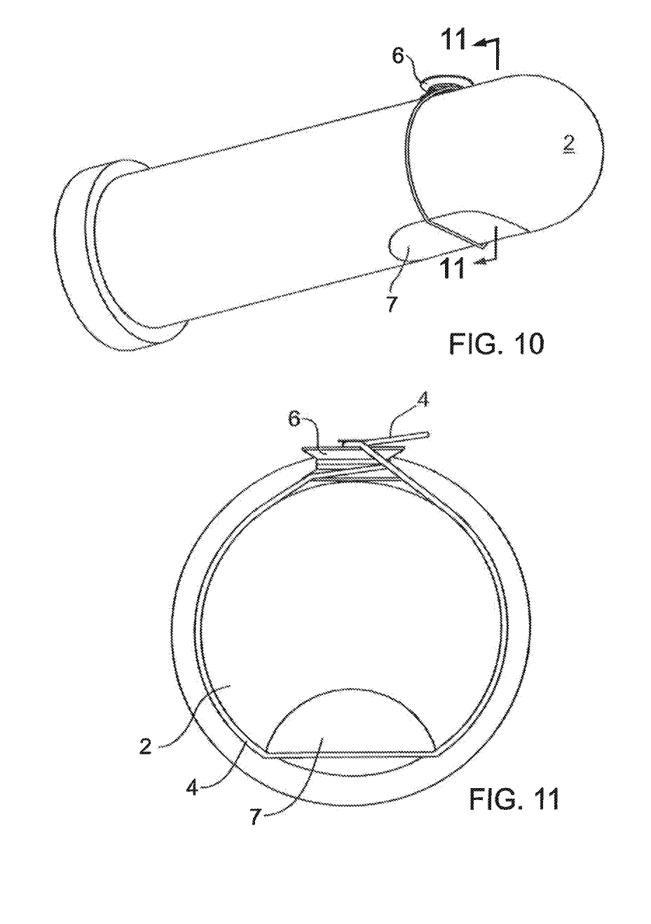

In the accompanying drawings, a tooth flossing device constructed in accordance with one of the embodiments of the invention is noted generally by reference numeral 1. Flossing device 1 is comprised of a sleeve 2 that is releasably receivable over the finger of a user. Flossing device 1 further includes a dental floss retainer 3 positioned on sleeve 2. Retainer 3 secures a length of dental floss 4 to the exterior surface of the sleeve. In FIGS. 1 through 6, dental floss retainer 3 comprises one or more hooks 5 positioned on the exterior surface of the sleeve and configured to retain a portion of the dental floss thereabout. It is expected that in most instances two hooks will be utilized as is shown more specifically in FIG. 6. In an alternate embodiment (see FIGS. 10 and 11) retainer 3 comprises a button member 6 positioned on the exterior surface of the sleeve that permits a length of dental floss to be wound about it. In a further alternate embodied both a button member and hooks may be utilized.

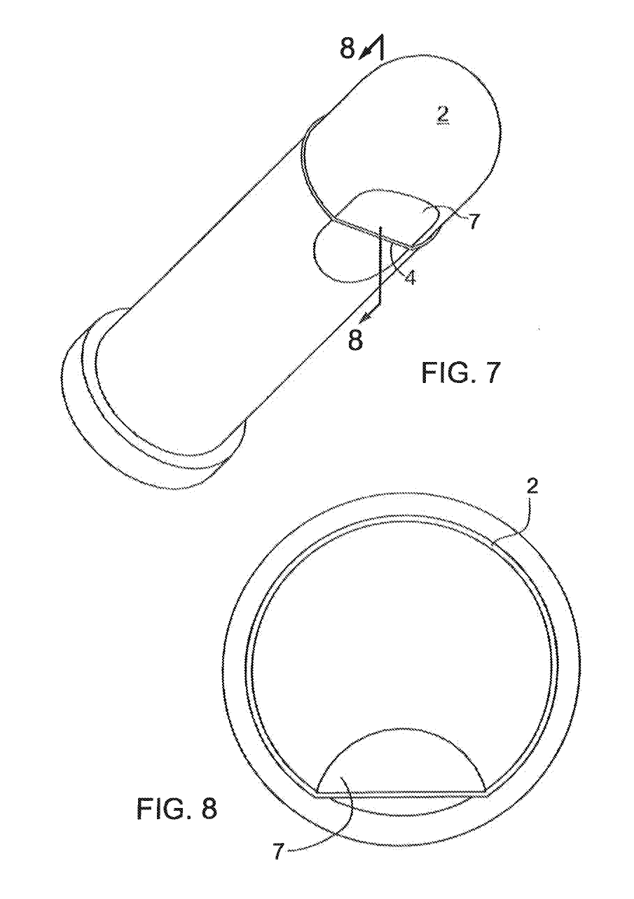

Referring to FIGS. 1 through 5, in one aspect sleeve 2 includes a longitudinally oriented channel 7 along its lower surface. Channel 7 may extend along the length of the sleeve (as shown in FIG. 1), or it may be shorter as is shown in FIG. 7. In a preferred embodiment, the width of channel 7 is slightly larger than the typical width of a tooth of an intended user. The channel is dimensioned to permit a plurality of teeth to be received therein.

It is expected that in most instances sleeve 2 will have an open end 8, to receive a user's finger, and a closed end 9. Where dental floss retainer 3 is comprised of a pair of hooks 5, the hooks will typically be oriented with their bills 10 extending toward closed end 9 of sleeve 2. In this manner, a length of dental floss 4 can be wound around one of the hooks, pass laterally around sleeve 2, and then be wound around the second hook with the two free ends of the floss extending longitudinally beyond open end 8 of the sleeve. It will be appreciated that the dental floss will extend laterally across longitudinal channel 7. When sleeve 2 is pushed downwardly over a user's teeth (identified by reference numeral 11 in the attached drawings) at least some of the teeth will be received within longitudinal channel 7 with the dental floss being inserted between two adjacent teeth. Securing the dental floss about hooks 5 helps to ensure that the floss is held tautly across longitudinal channel 7 to enhance the ability to insert the floss between two adjacent teeth. Sleeve 2, having dental floss 4 secured to it and being received over the finger of a user, thus allows the user to easily and effectively floss between adjacent teeth by depressing the sleeve over the teeth and moving the sleeve inwardly and outwardly and in a side to side motion. It should also be noted that with the depth of the longitudinal channel approximating the height of the intended user's teeth, the likelihood of pushing the dental floss too far into the teeth such that it cuts or irritates the gum will be greatly diminished. It will further be appreciated that the size and depth of longitudinal channel 7 can be altered for different sleeves designed for use on very small children, adolescents, or adults, each of whom will have teeth of different sizes. It is expected that in many instances sleeve 2 will be formed from silicone or rubber which will not only present an easily cleanable and sanitizible surface, but which will provide a degree of protection to the user's finger in situations where the flossing device is used on individuals who may tend to bite down on the user's finger when inserted into their mouth.

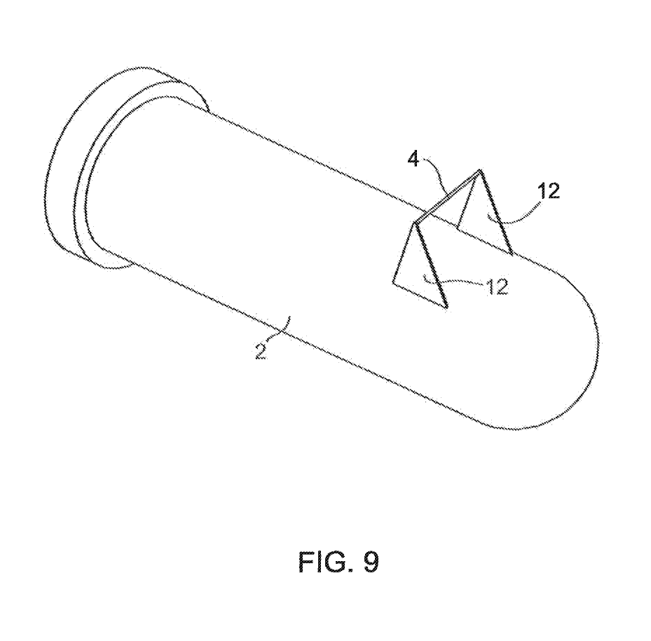

An alternate embodiment of the invention is shown in FIG. 9. In FIG. 9 dental floss retainer 3 comprises a pair of arms 12 that extend outwardly from the surface of sleeve 2. A length of dental floss 4 extends between arms 12 and is set-off a predetermined distance from the surface of the sleeve. The set-off of the dental floss from the sleeve's surface will be determined by the height of the arms, which will be a function of the height of the teeth of the individual upon which flossing device 1 is designed to be used. For example, in the case of an infant or small child the arms may be relatively short which will have the effect of only permitting dental floss to be inserted a limited degree between two adjacent teeth. In the case of an adult having larger teeth, the length of arms 12 may be increased. Arms 12 may also be designed to enable them to releasably secure the dental floss so that the floss can be easily replaced when it becomes frayed or broken, or the dental floss may be permanently attached to the arms. In addition, a button member and/or one or more hooks, as described above, may also be used in conjunction with the embodiment shown in FIG. 9.

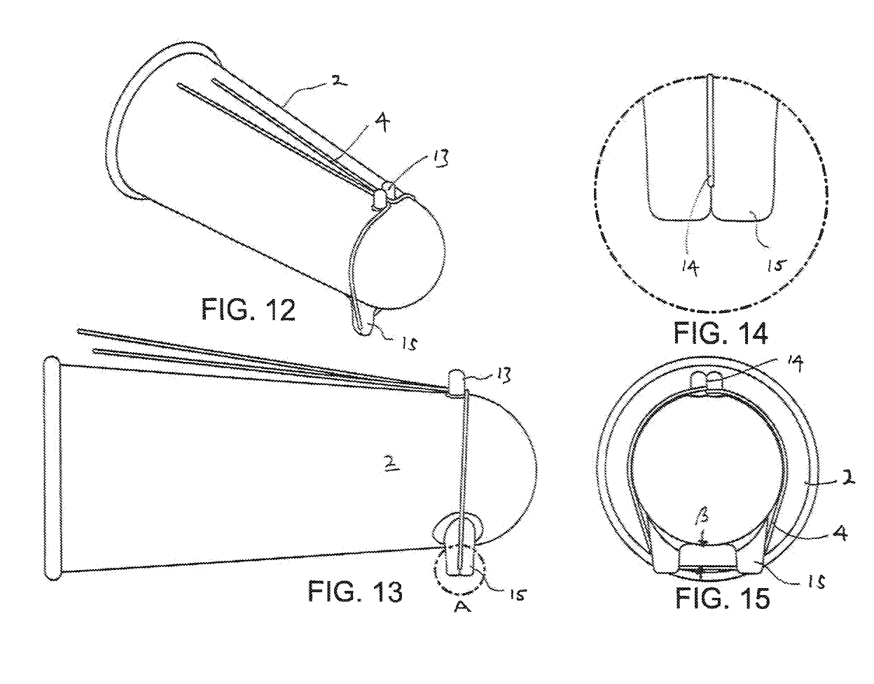

A further alternate embodiment of the invention is shown in FIGS. 12 through 15. In this embodiment, rather than incorporating one or more hooks on the exterior surface of the sleeve to retain a portion of the dental floss, sleeve 2 includes an upwardly extending post 13 having a generally vertically oriented slot or slit 14 therein for receiving the dental floss. Slot 14 is sufficiently narrow such that when dental floss is inserted into the slot the floss will be frictionally held in a relatively tight configuration within the slot. The lower end portion of the sleeve is fitted with a pair of leg members 15 on each side. In one embodiment of the invention leg members 15 are approximately parallel to one another and are spaced apart by from about 5 to about 7 mm. Each leg member also contains a narrow slot or slit 14 that receives the dental floss therein and that frictionally secures the dental floss at an angle of approximately 90 degrees to the longitudinal axis of the sleeve. In one of the preferred embodiments sleeve 2, post 13 and leg members 15 are unitarily molded from a rubberized, silicone, plastic or other such or similar material such that the frictional engagement of the dental floss within the narrow slots in both the post and the leg members assists in helping to tightly hold the dental floss in place, thereby assisting in permitting the floss to be inserted between a user's teeth without significant slippage of the floss within the slots.

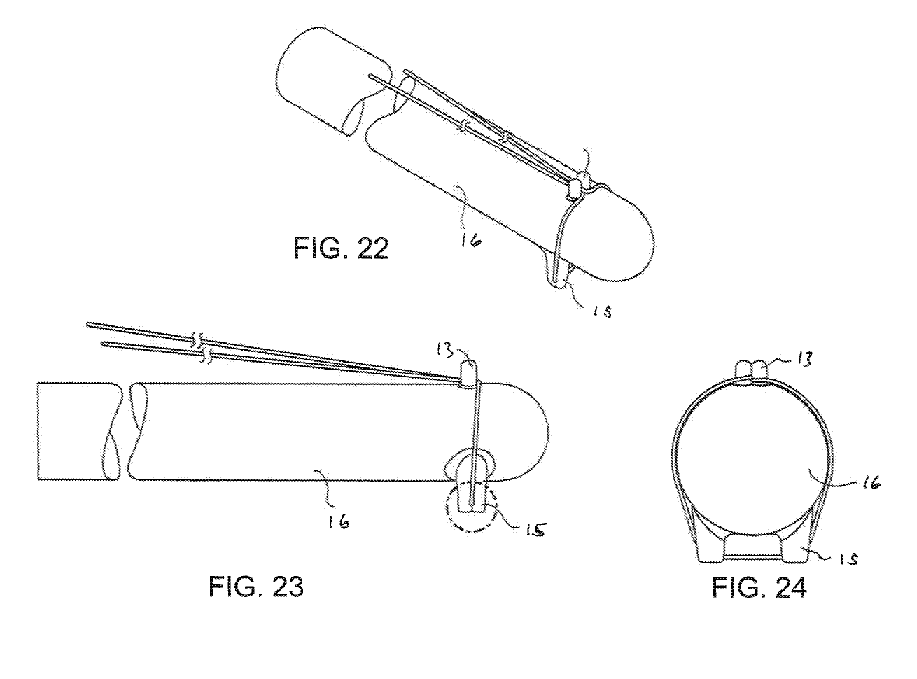

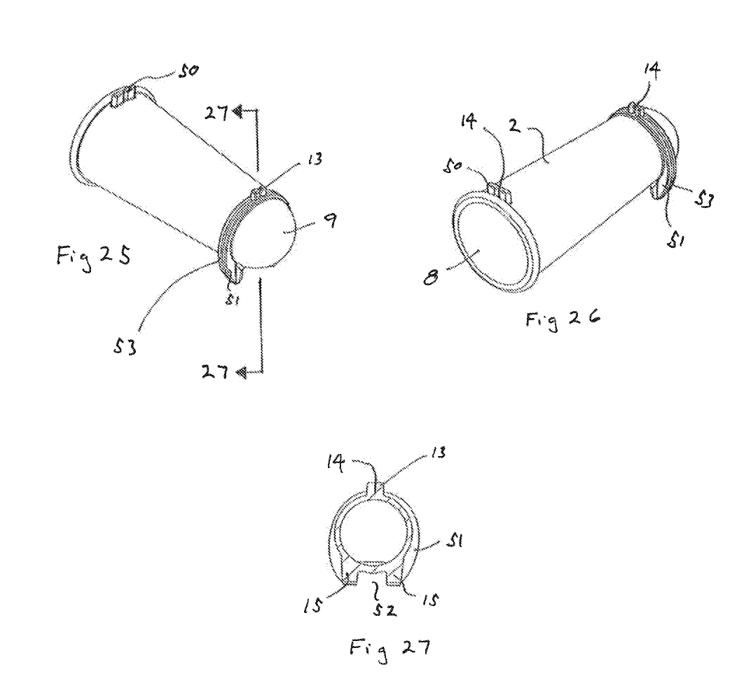

FIGS. 22 through 24 show an embodiment of the tooth flossing device similar to that shown in FIGS. 12 through 15, however, in this instance rather than utilizing a sleeve 2, the main body of the tooth flossing device is comprised of a solid (or generally solid) rigid or semi-rigid handle 16. Handle 16 could also be the end of an otherwise standard toothbrush. Use of the device depicted in FIGS. 22 through 24 thus merely requires the grasping of handle 16, inserting the handle into the mouth of the user (much as would be the case when using a standard tooth brush) and then inserting the floss between the user's teeth.

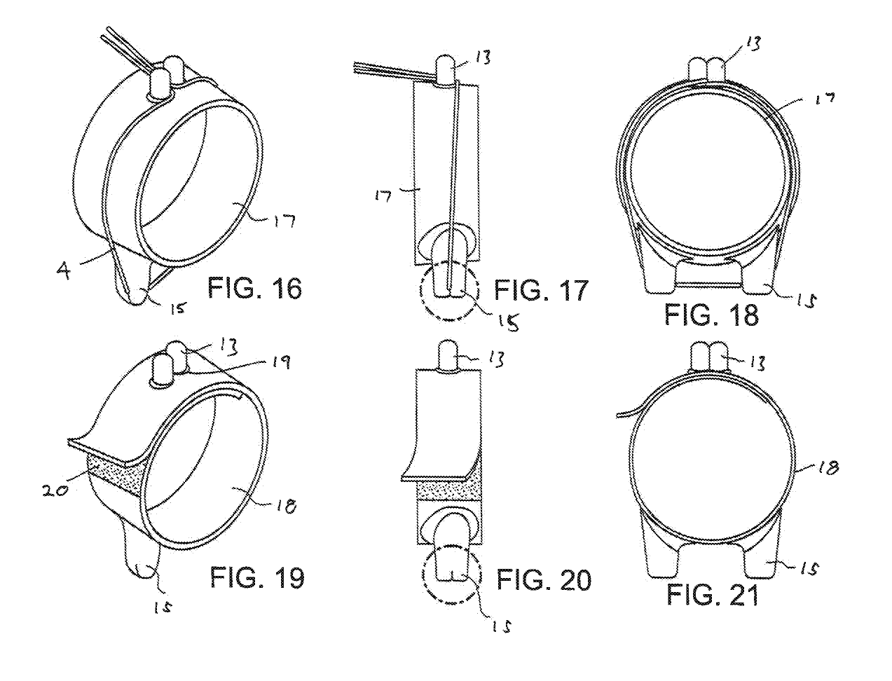

FIGS. 16 through 18 show yet a further embodiment of the invention wherein sleeve 12 is truncated, is of a reduced axial length, and is generally in the form of a relatively narrow open-ended ring 17. Otherwise, the embodiment shown in FIGS. 16 through 18 is essentially the same as that shown in FIGS. 12 through 15, except that rather than requiring the user to insert his or her finger into sleeve 2, the user merely has to slide ring 17 over a finger, or over the handle of a toothbrush or other elongate article that could be utilized when flossing one's teeth. It is expected that in most instances ring 17 will be formed from a rubber-like, silicone or similar material that will allow a degree of flexibility to accommodate fingers of different sizes and that will also allow a degree of stretching so that ring 17 can be securely held about the exterior of the user's finger.

In FIGS. 19 through 21 there is shown a modification of the embodiment of the invention shown in FIGS. 16 through 18. Here, the main body of the tooth flossing device is in the form of a strap 18 that is wound around the user's finger or the handle of a toothbrush or similar object. As shown, one portion or end of the strap will typically have mount upon it post 13, with the other portion or end of the strap may have an opening (or a series of openings) 19 to receive the post therethrough. Multiple openings in the opposite end of the strap will more readily permit the diameter of the strap to be “adjusted” to accommodate the size of the finger of different users. Alternately, a elongate slot could be used in place of opening 19. The strap may also include a fastener to aid in more securely holding it about the user's finger. In the particular embodiment that is shown, a hook and loop fastener 20 has been chosen for illustration purposes, however, it will be appreciated that other forms of fasteners could equally be used.

FIGS. 25 through 27 show yet a further embodiment of the invention. The embodiment that is depicted here is generally similar to that shown in FIGS. 12 through 15. In FIGS. 25 through 27, sleeve 2 includes a second upwardly extending post 50, having a generally vertically oriented slot or slit 14 therein for receiving the dental floss. Post 50 is situated generally adjacent to open end 8 of sleeve 2 and, as in the case of post 13, is positioned on the upper portion of the sleeve. Post 50, in conjunction with post 13, serves to receive the dental floss and to help to tightly hold the floss along the longitudinal axis of the sleeve. The two posts further help to hold and direct the dental floss from end 9 to end 8 of the sleeve and to guide the floss out of the individual's mouth when the tooth flossing device is in operation. It will be appreciated that the frictional engagement of the dental floss in slots 14 within posts 50 and 13 will also aid in helping to maintain the floss in a taught configuration between leg members 15. If desired the dental floss could also be looped or wound about one or both of posts 50 and 13 to further help hold the floss tightly between legs 15. While not shown in the previous embodiments described above, the use of a second post 50 could be incorporated into the previously described embodiments, including those shown in FIG. 1, FIG. 12, and FIG. 22.

It will also be noted that the embodiment of FIGS. 25 through 27 includes a guide/stability member 51 that extends at least partially about the exterior circumference of sleeve 2. The guide member is preferably of unitary construction with the legs members or is otherwise rigidly attached or secured to leg members 15. In the particular embodiment shown, guide member 51 extends from the outer portion of one of the leg members 15 around the upper circumference of sleeve 2 and terminates at the outer portion of the opposite or second leg member 15. That is, in this embodiment the guide member does not extend within the space 52 between the two leg members. In other embodiments of the invention (not shown) guide member 51 could be discontinuous about the upper circumference of the sleeve and could effectively be in the form of two or more discrete guide member sections. It will be understood from an examination of FIGS. 25 through 27 that where the guide member is continuous about the upper circumference of the sleeve, post 13 will extend vertically upward through the guide member.

The exterior surface of guide member 51 may include one or more relatively narrow circumferential grooves 53 that are intended to receive the dental floss that extends about the circumference of the guide member. The receipt of the floss within the grooves will tend to more securely hold the floss about the exterior surface of the guide member, and will help to prevent the floss from shifting or being displaced longitudinally along the axis of the sleeve 2. In an alternate embodiment of the guide member the groove or grooves 53 are in the form of narrow slits or slots into which the dental floss is received, wherein the friction between the slits and the dental floss further enhances the retaining of the dental floss about the sleeve and further helps to maintain the floss between the leg members in a taught configuration.

Guide member 51 also serves the added purpose of helping to provide rigidity or stability to the end of the sleeve about which it is received, and helping to stabilize leg members 15. That is, since the guide member is formed with, or otherwise secured or attached to, the leg members, it will provide added stability to members 15. Through enhancing the stability of the leg members, when the tooth flossing device is in operation there will be less of a tendency for the legs to be displaced when dental floss is pushed between two adjacent teeth.

Sleeve 2, posts 13 and 50, leg members 15 and guide member 51 could be of unitary construction and formed or molded from a common silicone, plastic, rubber or other material. Alternately, the guide member could be formed or manufactured separately (from the same or a different material from which the sleeve is manufactured) and later attached to the sleeve (and leg members) through the use of an adhesive, through heat welding, through friction fitting or through use of any one of a wide variety of other fastening mechanisms or methodologies. In a further embodiment the guide member and the legs could be of unitary construction and formed separately from the rest of the sleeve and later attached thereto. In still a further embodiment end 9 of the sleeve, together with post 13, leg members 15 and guide member 51 could be of unitary construction and formed from a somewhat more rigid material than that of the remainder of sleeve 2, with the two portions of the sleeve secured together through use of an adhesive, a mechanical fastener, through heat welding or through mechanical and/or chemical bonding during the manufacturing or molding process. It will also be appreciated that guide member 51 could be incorporated into the embodiments of the invention depicted in FIGS. 12, 16, 19 and 22.

As in the case of previously described embodiments, the embodiments of FIGS. 12 through 27 are designed to limit the extent that the dental floss can be inserted between adjacent teeth. It is expected that in most instances the distance between the floss (when held within slots 14 of leg members 15) and the lower most portion of the sleeve immediately adjacent to the floss will be from approximately 1 mm to approximately 2½ mm (see β in FIG. 15). This distance generally reflects the distance from the occlusal plane to the inner proximal gum tissue of many individuals. Through sizing leg members 15 in this manner the user will be unable to push the dental floss beyond a pre-determined limit between adjacent teeth, thereby helping to prevent excessive impinging upon the gums that can result in cutting or irritating gum tissue.

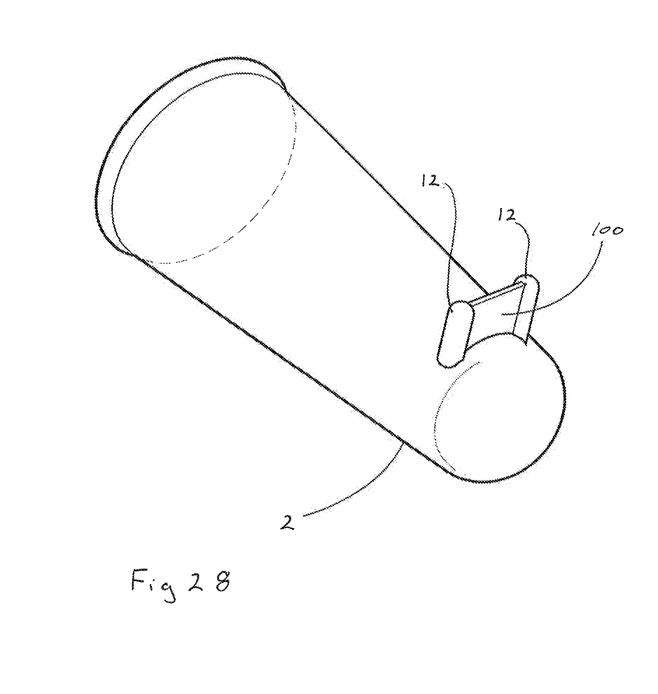

FIG. 28 shows a further embodiment of the tooth flossing device. In the embodiment of FIG. 28, as in that of the embodiment of FIG. 9, sleeve 2 includes a pair of arms 12 that extend outwardly from the exterior of the sleeve's surface. For illustration purposes, in the particular embodiment that is show arms 12 extend outwardly from the sleeve's surface at an angle of approximately 90°, however, it will be appreciated that other angles of inclination could equally be used.

Positioned between arms 12 is a thin “flossing” wall 100 that effectively takes the place of the dental floss 4 that is used in the embodiment of FIG. 9. Flossing wall 100 has a thickness generally approximating that of standard dental floss and can be inserted into the spaces between two adjacent teeth in a manner similar to the dental floss of the embodiment of FIG. 9. That is, the sleeve can be inserted into the mouth of an individual with arms 12 aligned with the space between two adjacent teeth such that pushing the sleeve toward the teeth allows wall 100 to be inserted between the teeth. Moving the sleeve in an up and down and/or side to side manner effectively permits the space between the teeth to be “flossed” by wall 100. To facilitate in the side to side movement of the flossing wall, the wall is preferably wider than the width of the teeth of the intended user.

As in the case of the embodiment shown in FIG. 9, the set-off of the outer surface of wall 100 from the sleeve's surface will largely be a function of the height of the teeth of the individual upon which the device is designed to be used. For example, in the case of an infant or small child, arms 12 and flossing wall 100 may be relatively short, which will have the effect of only allowing flossing wall 100 to be inserted to a limited degree between two adjacent teeth. In the case of an adult having larger teeth, the length of arms 12 and flossing wall 100 may be increased. In one embodiment, the wall could be from about 0.8 to 1.0 millimeters in thickness, approximately 1 centimeter long and approximately 5 millimeters tall.

It will also be appreciated that flossing wall 100 could equally be used without arms 12. Further, as in the case of prior embodiments discussed above, sleeve 2 may be a closed ended sleeve or an open ended sleeve. As well, rather than being positioned on a sleeve, flossing wall 100, with or without arms 12, could be positioned on a strap similar to the embodiment shown in FIGS. 19-21, on an open ended ring similar to the embodiment shown in FIGS. 16-18, or on handle similar to the embodiment shown in FIGS. 22-24.

In FIG. 28 flossing wall 100 is depicted as comprising a continuous, solid, wall that extends outwardly from the surface of the sleeve. However, wall 100 could equally be perforated and/or could be disconnected from direct contact with the exterior of the sleeve, forming a web that spans between arms 12. One or more of the exterior surfaces of wall 100 could have a “roughness” or “grit” (formed by very small ridges, nibs, etc molded into the wall, or formed through the incorporation of a gritty or somewhat abrasive substance into or onto the surface of the wall) to help improve cleaning effectiveness. If desired, wall 100 may further contain a flavour exuding compound that slowly discharges a flavouring agent during use. Alternately, or in addition to a flavouring agent, wall 100 may further include a medicament that is released into them mouth of a user during operation of the device. Such flavour and/or medicament exuding compounds may also be included within small bead-like structures positioned on the exterior of wall 100.

It is expected that in most instances sleeve 2, arms 12 and wall 100 will be unitarily molded from the same material. It is also expected that in most instances that material will be a silicone or a relatively soft, pliable, plastic or rubber-type material. Depending upon the individual upon whom the device is to be used, the durometer or “softness” of the material (and particularly wall 100) can be varied. For example, where the device is to be used on the teeth of an infant or small child, wall 100 may be formed from a relatively soft and pliable material so as to allow for an effective cleaning between the teeth without excess irritation of the gums. In the case of an adult, wall 100 may in some cases be formed from a slightly more rigid material.

From a thorough understanding of the invention, it will thus be appreciated that there is provided an improved tooth flossing device that facilitates “flossing” between teeth while limiting the likelihood of the floss (or wall 100 in the case of the embodiment shown in FIG. 28) being pushed into the gums with such a force, or to such an extent, that it causes a cutting or excess irritation of the gums. In some embodiments the device may also protect the user's finger from being bitten or from coming into contact with the saliva of an individual whose teeth are being flossed by a parent or caregiver, presenting improved safety and hygiene, and reducing the potential transmission of bacteria and viruses. Although not shown in the attached drawings, in instances where the individual may suffer from a communicable disease, sleeve 2 may be attached to, or form part of, a glove or an impermeable shield that further protects the hand of the user from coming into contact with the oral cavity of the individual whose teeth are being flossed. The device may be constructed for a one-time disposable use. Further, where the device is used with dental floss, should the floss become stuck between two adjacent teeth (for example, where there is crowding and the teeth are close together or where the floss becomes trapped beneath an overhang or by a rough filling) described tooth flossing device will enable the floss to be easily freed by simply releasing one end of the floss from the device and pulling on the opposite end to permit the floss to be pulled lengthwise from between the teeth in question.

It is to be understood that what has been described are the preferred embodiments of the invention. The scope of the claims should not be limited by the preferred embodiments set forth above, but should be given the broadest interpretation consistent with the description as a whole.

I claim:

1. A tooth flossing device comprising a sleeve and a dental floss retainer, said sleeve releasably receivable over the finger of a user, said dental floss retainer assisting in securing a length of dental floss to said sleeve such that said sleeve, when received over the finger of a user, assists in the insertion of the dental floss between the teeth of the user or another, said dental floss retainer comprising a pair of leg members extending outwardly from the surface of said sleeve, said leg members having slots dimensioned such that receipt of dental floss into said slots causes a frictional engagement between said slots and the dental floss to releasably secure the dental floss between said leg members, said leg members and said slots arranged such that when dental floss is secured between said leg members the dental floss is generally perpendicular to the longitudinal axis of said sleeve, the distance between the dental floss, when secured between said leg members, and said sleeve determining the extent to which the dental floss can be inserted between the teeth of a user or another.

2. The tooth flossing device as claimed in claim 1 wherein said sleeve includes a longitudinally oriented channel, the dental floss extending laterally across said channel such that teeth are receivable within said channel with the dental floss inserted between adjacent teeth as said sleeve is depressed over the teeth, the distance between the dental floss and said channel determining the extent that the dental floss can be inserted between the teeth of a user or another.

3. The tooth flossing device as claimed in claim 1 further including one or more posts on the exterior surface of said sleeve and configured to assist in retaining a portion of the length dental floss to said sleeve.

4. The tooth flossing device as claimed in claim 3 including a guide member extending about at least a portion of the circumference of said sleeve, said guide member assisting in maintaining dental floss about the surface of said sleeve, said guide member enhancing the rigidity of said leg members to assist in preventing the displacement of said leg members when dental floss retained therebetween is inserted between the teeth of a user or another.

5. The tooth flossing device as claimed in claim 4 wherein said sleeve has a first open end and a second enclosed end.

6. The tooth flossing device as claimed in claim 1 wherein said sleeve is in the form of an open-ended ring of diminished axial length such that said ring is receivable over a portion of the finger of a user, or over a handle.

7. The tooth flossing device as claimed in claim 6 wherein said ring is comprised of a strap having overlapping ends to form a generally circular structure.

8. The tooth flossing device as claimed in claim 7 wherein said strap includes a fastener that permits said ring to be formed having one or more diameters.

9. A tooth flossing device comprising an elongate handle and a dental floss retainer positioned on said handle, said dental floss retainer assisting in securing a length of dental floss to said handle, said dental floss retainer comprising a pair of leg members extending outwardly from the surface of said handle, said leg members having slots dimensioned such that receipt of dental floss into said slots causes a frictional engagement between said slots and the dental floss to aid in securing the dental floss between said leg members, said leg members and said slots arranged such that when dental floss is secured between said leg members the dental floss is generally perpendicular to the longitudinal axis of said handle, the distance between the dental floss, when secured between said leg members, and said handle determining the extent to which the dental floss can be inserted between the teeth of a user or another.

10. The tooth flossing device as claimed in claim 9 including one or more posts on said handle, said posts configured to assist in securing said dental floss to said handle.

11. The tooth flossing device as claimed in claim 1 wherein said leg members are dimensioned such that when dental floss is secured between said leg members said dental floss is positioned from approximately 1 millimetre to approximately 2.5 millimetres from said sleeve.

12. The tooth flossing device as claimed in claim 1 further including a guide member extending about at least a portion of the circumference of said sleeve, said guide member assisting in maintaining dental floss about the surface of said sleeve.

13. The tooth flossing device as claimed in claim 12 wherein said guide member enhances the rigidity of said leg members to assist in preventing the displacement of said leg members when dental floss retained therebetween is inserted between the teeth of a user or another.

14. A tooth flossing device comprising a sleeve and a dental floss retainer, said sleeve releasably receivable over the finger of a user, said dental floss retainer positioned on said sleeve and assisting in securing a length of dental floss to said sleeve such that said sleeve, when received over the finger of a user, assists in the insertion of the dental floss between the teeth of the user or another, said dental floss retainer comprising a pair of leg members and a guide member, said leg members extending outwardly from the surface of said sleeve and arranged to permit dental floss to extend between said leg members in a generally perpendicular relationship with respect to the longitudinal axis of said sleeve, said guide member extending about at least a portion of the circumference of said sleeve.

15. The tooth flossing device as claimed in claim 14 wherein said guide member assists in maintaining dental floss about the surface of said sleeve.

16. The tooth flossing device as claimed in claim 14 wherein said guide member enhances the rigidity of said leg members to assist in preventing the displacement of said leg members when dental floss retained therebetween is inserted between, or removed from, the teeth of a user or another.

17. A tooth flossing device comprising a flossing wall mounted to a central body, said flossing wall having a width exceeding that of the width of the teeth of an intended user and a thickness that permits the insertion of said flossing wall between adjacent teeth of the user, such that when said flossing wall is inserted between adjacent teeth of a user movement of said central body in an up and down or a side to side manner relative to the user's teeth causes said flossing wall to clean between said teeth.

18. The tooth flossing device as claimed in claim 17 including a pair of arms extending outwardly from the surface of said central body, said flossing wall extending between said arms.

19. The tooth flossing device as claimed in claim 18 wherein said flossing wall is mounted directly on, and extends outwardly from, the surface of said central body.

20. The tooth flossing device as claimed in claim 18 wherein said flossing wall includes perforations.

21. The tooth flossing device as claimed in claim 18 wherein said flossing wall has one or more roughened or abrasive exterior surfaces.

22. The tooth flossing device as claimed in claim 21 wherein said flossing wall includes one or both of a flavouring agent and a medicament that are released into the mouth of an individual during use of said tooth flossing device.

23. The tooth flossing device as claimed in claim 19 wherein said arms and said flossing wall extend outwardly from the surface of said central body at an angle of approximately 90°.

24. The tooth flossing device as claimed in claim 18 wherein said central body comprises a sleeve, said sleeve releasably receivable over the finger of a user.

25. The tooth flossing device as claimed in claim 18 wherein said central body comprises an elongate handle, a strap or an open ended ring.
